(19) United States
(12) Patent Application Publication
(10) Pub. No.: US 2004/0140910 A1
(43) Pub. Date: Jul. 22, 2004

(54) Emergency visual alerting system (EVAS)

(76) Inventor: Roger Wroy Jordan, Glendale, AZ (US)

Correspondence Address: ROGER WROY JORDAN, 5734 WEST CINNABAR AVE, GLENDALE, AZ, 85302, US

(21) Appl. No.: 10/347,419

(22) Filed: Jan. 21, 2003

(51) Int. Cl. G08G 1/095

(52) U.S. Cl. 340/907; 340/815.45

(57) ABSTRACT

Emergency Visual Alerting System (EVAS) is primarily a garage door opener type transmitter, with a receiver and antenna attached to a grid of LED lights that when activated flash on and off. EVAS can operate independently or integrated with the existing traffic signals. This system is also equipped with a battery backup that activates in the event of a power outage. Customers may elect to use only the battery backup system for power outages and not use the transmitter/receiver features.

### CROSS-REFERENCE TO RELATED APPLICATIONS

No claims are being made for any prior non provisional patents. However, the provisional information for this non-provisional claim is as follows:

Application No. 60/348,990

Filing Date Jan. 16, 2002

Confirmation No. 5865

### STATEMENT REGARDING FEDERALLY SPONSORED RESEARCH OR DEVELOPMENT

This invention was not produced under any federally sponsored programs.

### REFERENCE TO SEQUENCE LISTING, A TABLE, OR A COMPUTER PROGRAM LISTING COMPACT DISK APPENDIX

Not applicable.

### BACKGROUND OF THE INVENTION

Emergency Visual Alerting System (EVAS) is a traffic control system to be used with the existing red, yellow and green traffic signals. It has two primary functions that can work independently or in conjunction with each other. One, red light activation by transmitter to alert traffic of emergencies, and two, Battery backup to flash red in the event of a power failure. Technology today now permits the use of this system primarily from an economical standpoint.

EVAS is to be used as a visual siren system that supplements the existing warning systems.

EVAS does not replace or supercede any existing system.

EVAS is to be installed, used and controlled primarily by cities and other controlled areas. ie. government facilities. The primary objectives of EVAS are as follows:

Increase safety for public traffic and emergency personnel.

Reduce response time for emergency personnel.

Decrease accidents with emergency equipment.

Decrease city liability from emergency vehicle accidents.

Research

All operators of motor vehicles are required to take written, driving and vision tests prior to receiving a valid operator license. To date, no state requires operators to take a hearing test.

Today's vehicles are equipped with amenities that quite often hamper the operators' ability to hear. For example, air conditioners, radios, stereos, headphones, and most recently cellular phones, hinder an operators' ability to hear. Operators today are relying primarily on visual awareness in traffic rather than vision and hearing.

Today's emergency vehicles are equipped with multiple audible sirens for warning. However, these sirens are most audible in the direction of the emergency vehicle and less audible to peripheral traffic. Traffic approaching an emergency vehicle from either side can and do have difficulty in hearing these sirens. The results in most cases are slower response time for the emergency vehicle or, in the worst case, an accident involving the emergency vehicle and public traffic.

Emergency personnel in the event of police pursuits can also use EVAS. Most cities have adopted a “no pursue” or “maintain visual” in pursuit situations. However, this does not prevent the fleeing vehicle from running red lights at intersections.

As stated earlier, EVAS can be activated by emergency personnel on foot, from vehicles or from the air. Quite often police maintain visual surveillance with a fleeing vehicle from the air. EVAS can be activated immediately for any direction to warn public traffic of impending danger.

### BRIEF SUMMARY OF THE INVENTION

Emergency Visual Alerting System (EVAS) is a traffic control system to be used with the existing red, yellow and green traffic signals. It has two primary functions that can work independently or in conjunction with each other. One, red light activation by transmitter to alert traffic of emergencies, and two, Battery backup to flash red in the event of a power failure. Technology today now permits the use of this system primarily from an economical standpoint.

EVAS is to be used as a visual siren system that supplements the existing warning systems.

EVAS does not replace or supercede any existing system.

EVAS is to be installed, used and controlled primarily by cities and other controlled areas. ie. government facilities. The primary objectives of EVAS are as follows:

Used as backup red light flashing during power outages

Increase safety for public traffic and emergency personnel.

Reduce response time for emergency personnel.

Decrease accidents with emergency equipment.

Decrease city liability from emergency vehicle accidents.

Technology today makes this system affordable to own and operate.

### BRIEF DESCRIPTION OF THE SEVERAL VIEWS OF THE DRAWING

Drawing/Sketches included are:

FIG. 1. Overall conceptual view of transmitter, receiver activating LED grid.

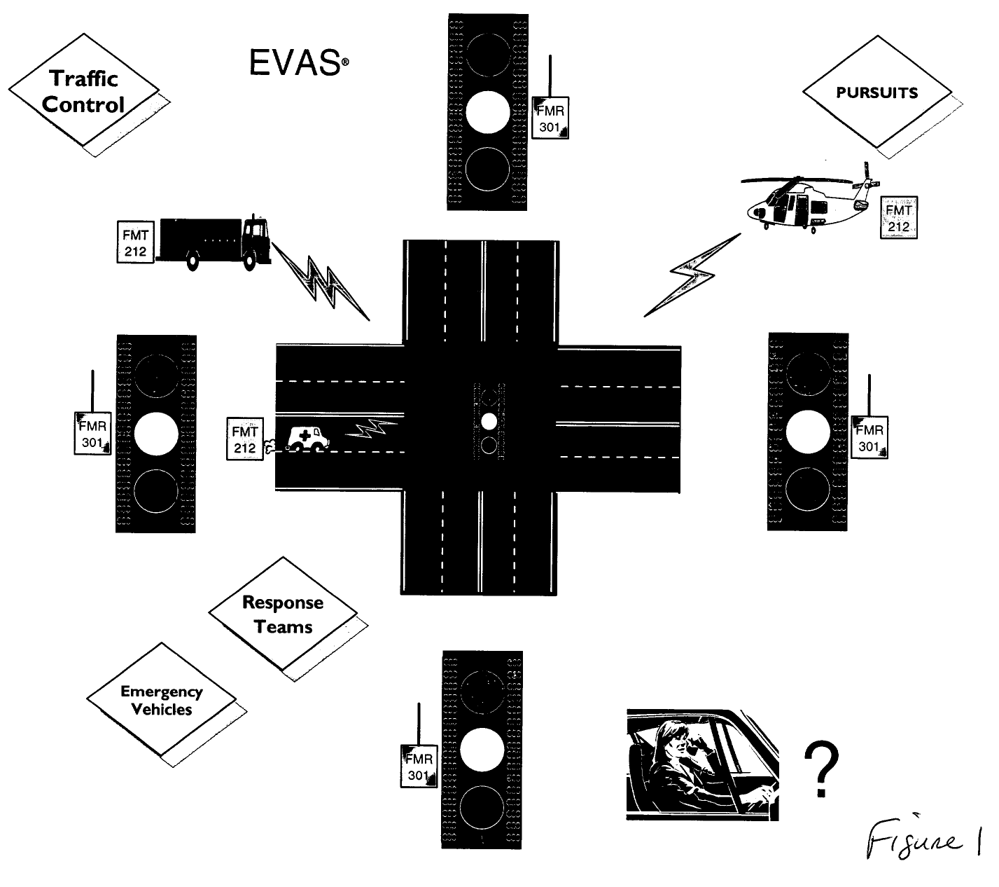

FIG. 2. Different variations, placement and colors for the LED grid.

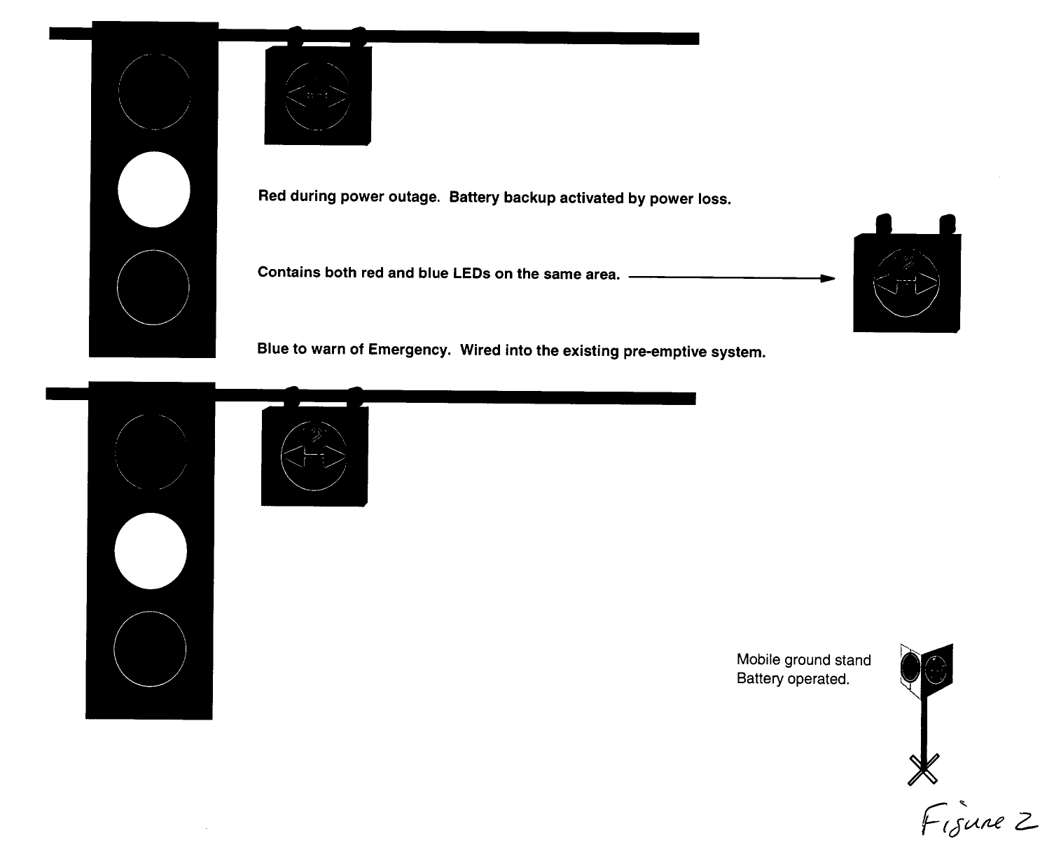

FIG. 3. Additional variations and placements for LED grids or red light replacement.

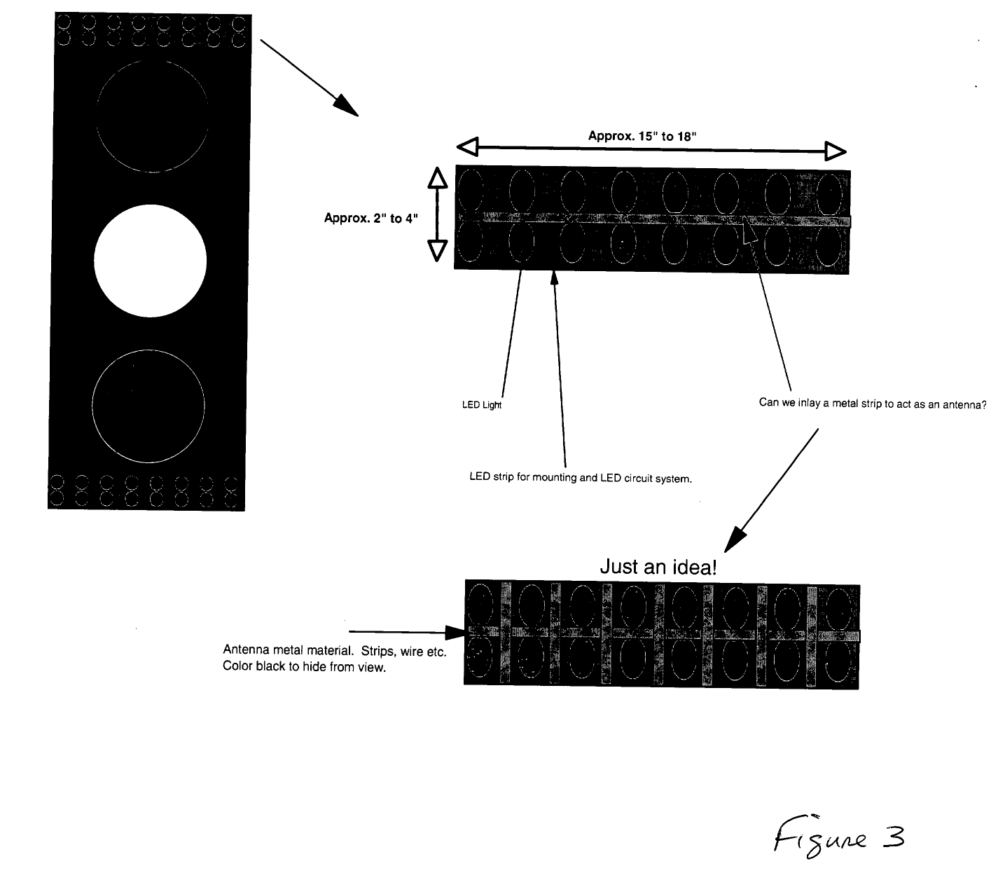

FIG. 4. Additional arrangements and configurations for LED grid.

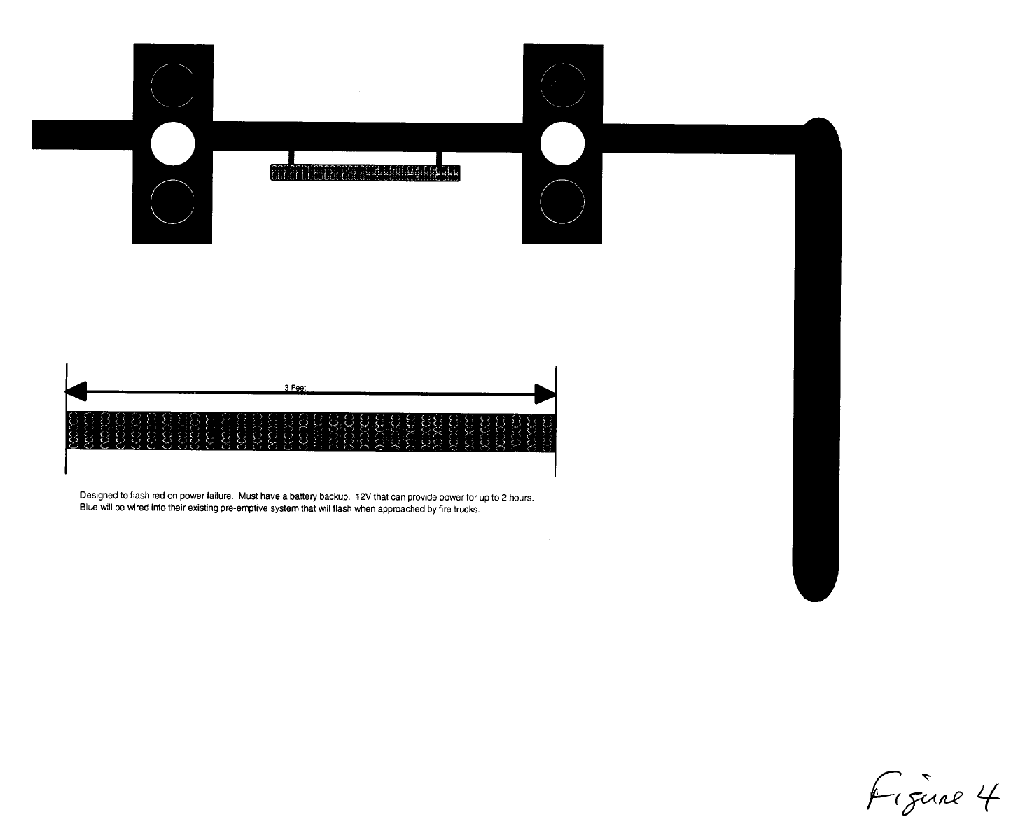

FIG. 5. Appearance when activated in one configuration.

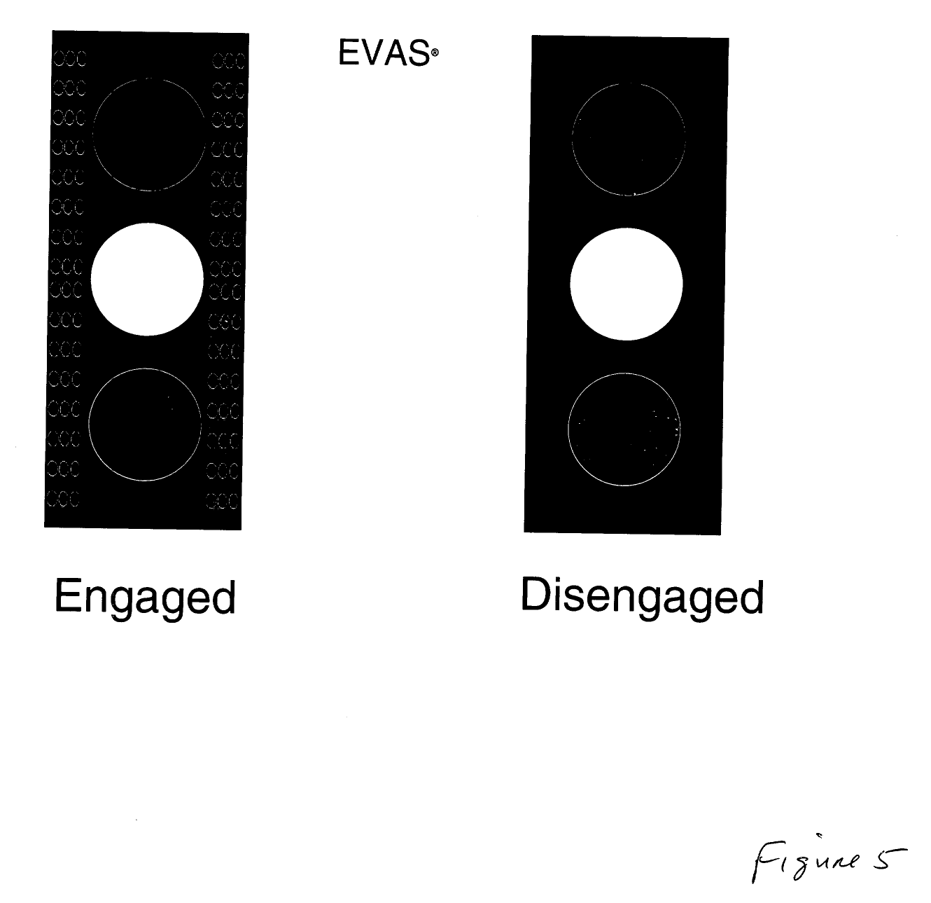

### DETAILED DESCRIPTION OF THE INVENTION

Emergency Visual Alerting System (EVAS).

EVAS is a system comprised of a handheld transmitter, a receiver with antenna equipped with a battery backup system and a circuit board for producing an output signal to drive an LED grid of lights.

This grid of LED's can be the same configuration, ie round red for installing into the existing red light area on the traffic signal, or it can be a strip of LED's affixed to the traffic signal as directed by the customer. In either case, the LED grid can be activated by either the transmitter or by a power failure.

Customers may elect to install this device and only use the battery backup for power failure. In this case a power failure would produce all red flashing lights that would be the same as a four way stop.

When activated by the transmitter the LED's flash on and off to alert traffic that an emergency is approaching. This system, when activated, provides a visual alert to traffic at an intersection that an emergency is approaching. This system can be viewed as a visual siren system that adds another form of warning to public traffic of an approaching emergency.

This system can be totally independent of the existing traffic lights or integrated in a fashion that when activated by a transmitter all red lights flash and the green and yellow are deactivated. (Customer preference.)

System Components

The transmitter is designed for uni-directional use with a range not greater than ¼ mile. It will be controlled and activated only by emergency personnel. ie. police, fire and medical personnel or as directed by each city government. The transmitter can be activated from emergency vehicles, emergency personnel on foot or from emergency personnel in the air.

The receiver and antenna should be mounted in a non obstructive area on each red, yellow and green traffic light and connected to each grid of LEDs. The receiver is designed to activate when energized from the transmitter. The receiver is also equipped with a battery backup that can be utilized during power outages at the intersections. This battery backup can be a rechargeable system of either drycell, wetcell, or solar charged systems that have a usage life of not less than four hours during power outages. (Current tests have exceeded 5 days)

LED lights can be various colors depending on customer preference. ie. red, yellow, blue, white, green, etc. The LED grids are affixed either in place of the current red light or on each side of the existing traffic lights and illuminate in a flashing pattern to provide visual warning.

Rationale

EVAS is to be used as a visual siren system that supplements the existing warning systems. EVAS does not replace or supercede any existing system.

EVAS is to be installed, used and controlled primarily by cities and other controlled areas. ie. government facilities. The primary objectives of EVAS are as follows:

Increase safety for public traffic and emergency personnel.

Reduce response time for emergency personnel.

Decrease accidents with emergency equipment.

Decrease city liability from emergency vehicle accidents.

Research

All operators of motor vehicles are required to take written, driving and vision tests prior to receiving a valid operator license. To date, no state requires operators to take a hearing test.

Today's vehicles are equipped with amenities that quite often hamper the operators' ability to hear. For example, air conditioners, radios, stereos, headphones, and most recently cellular phones, hinder an operators' ability to hear. Operators today are relying primarily on visual awareness in traffic rather than vision and hearing.

Today's emergency vehicles are equipped with multiple audible sirens for warning. However, these sirens are most audible in the direction of the emergency vehicle and less audible to peripheral traffic. Traffic approaching an emergency vehicle from either side can and do have difficulty in hearing these sirens. The results in most cases are slower response time for the emergency vehicle or, in the worst case, an accident involving the emergency vehicle and public traffic.

EVAS can also be used by emergency personnel in the event of police pursuits. Most cities have adopted a “no pursue” or “maintain visual” in pursuit situations. However, this does not prevent the fleeing vehicle from running red lights at intersections.

As stated earlier, EVAS can be activated by emergency personnel on foot, from vehicles or from the air. Quite often police maintain visual surveillance with a fleeing vehicle from the air. EVAS can be activated immediately for any direction to warn public traffic of impending danger.

Features and/or Options.

EVAS is equipped with a battery backup system. When activated, due to a power outage, all lights in the intersection are energized thus producing the same effect as a four way stop.

Motion detection can be added as another feature to notify emergency personnel that all vehicles in an intersection have stopped, thus allowing a safer and more timely response to the emergency.

Readable LED signs can be installed in place of or along with the existing grid.

Different color LED lights can be used for varying emergencies and public responses.

1. What I claim as my invention is a grid of red LEDs on a circuit board with a battery/solar backup system to provide red flashing lights in intersections during power outages.

2. What I claim as my invention is a system composed of a transmitter, receiver, antenna, battery backup system and LED grid that when activated by the transmitter produces a flashing warning light.

3. What I claim as my invention is a combination of claims I & II. A system with a transmitter, receiver, antenna and LED grid and a battery backup system.

4. What I claim as my invention is an economically affordable system with the latest technology in LED circuitry that will provide the public with a visual warning system for emergency situations.
